(19) United States
(12) Patent Application Publication
(10) Pub. No.: US 2014/0254062 A1
(43) Pub. Date: Sep. 11, 2014

(54) Multi layer Smectite Capacitor (MLSC)

(71) Applicants: Davood Namdar Khojasteh, Tehran (IR); Mehdi Shorafa, Karaj (IR)

(72) Inventors: Davood Namdar Khojasteh, Tehran (IR); Mehdi Shorafa, Karaj (IR)

(21) Appl. No.: 13/786,427

(22) Filed: Mar. 5, 2013

(51) Int. Cl. H01G 4/08

(52) U.S. Cl. CPC H01G 4/08
USPC 361/301.4

(57) ABSTRACT

Multilayer smectite capacitor (MLSC) provided with a new dielectric film, and a first electric and second electrode formed sandwiching it and facing each other, wherein has dielectric film. The dielectric film in this capacitor is smectite, and either or both of said first electrode and second electrode contain at least one metal selected from group consisting of Cu, Ni. Thin internal conductors are each placed between the smectite dielectric layer and arranged in parallel. The smectite dielectric layers have a thickness of about 0.6 to less than 2 micrometer. The internal conductors have a thickness of about 0.2 to 0.4 micrometer.

### FIELD OF THE INVENTION

The present invention relates to new capacitor that called Multilayer Smectite Capacitor (MLSC).

### DESCRIPTION OF THE RELATED ART

In electronics industries, Mica and Ceramic capacitors including a ceramic and mica body and internal conductors placed therein have been widely used. In such capacitors dielectric layers are each places between the internal conductors. Since, these has been a demand for a decrease in size, increase in capacity, and decrease in cost. In general a decrease in thickness of layer the number of dielectric particle placed in the thickness direction of dielectric layer and increases the electric field applied to the dialectic layer; hence, the reliability of the dielectric layer is decreased (U.S. Pat. No. 7,545,626 B1, U.S. Pat. No. 7,085,124 B2).

Therefore, in order to increase reliability, the average size of the particles has been reduced. For conductive material for forming internal conductors, a base metal such as Ni and Cu has been used instead of a metal such as Ag, whereby, low cost capacitors have been developed. In the other hand in order to increase the capacity of capacitors, it is presumed that dielectric layer thickness must be reduced or dielectric constant must be increased. Active research has been conducted in recent years on capacitors that are provide with dielectric thin films formed on Ni foils or Cu foils. The dielectric material that are primary used for dielectric are metal oxides material such as barium strontium titanate (Ba,Sr) TiO3, abbreviate as BSP), or lead zirconate titanate ((PB,Zr) TIO3, abbreviated as PZT) and other dielectric materials that have been used are paper, ceramic, mica, and etc. increasing the dielectric constant can yield a capacitor with a large electrostatic capacity.

### SUMMARY OF THE INVENTION

There are many types of smectite. It is thermally stable up to 550° C., and has a high dielectric strength but it may be used up to 900° C. Natural smectite has to be carefully selected because some samples do contain impurities including, iron, sodium, ferric oxide, and lithium. This introduces some variability into any smectite that might be used for capacitor manufacture and therefore it must be carefully inspected and classified.

The multilayer smectite capacitor has many-layered dielectric. The smectite dielectric obviously forms the basis for multilayer smectite capacitor. It also can be used for capacitor because of its combination of stability and general physical and mechanical attributes. Although there are several different forms of smectite, they all have different properties. They are fundamentally very stable both mechanically and chemically, the material has a dielectric constant ranging from around 8.5 to 10.5. The capacitance value of a capacitor is determined by four factors. The number of layers in the part, the dielectric constant and the active area are all directly related to the capacitance value. The dielectric constant is determined by the smectite. The active area is just the overlap between two opposing electrodes. The dielectric thickness is inversely related to the capacitance value, so the thicker the dielectric, the lower the capacitance value. This also determines the voltage rating of the part, with the thicker dielectric having a higher voltage rating that the thinner one.

An object of the invention is to provide a capacitor comprising a dielectric film capable of exhibiting sufficiently high dielectric constant. It is another object of the invention to provide a dielectric film capable of exhibiting sufficiently high dielectric constant. The present have conducted diligent research with an aim of overcoming the problem of low dielectric material, in many capacitors such as mica capacitor, that have been used such as mica, paper, and etc and have discovered that a type of smectite minerals have more dielectric constant than other mineral such as mica. As a result of further research based on this knowledge, the present invention was completed.

Specifically, the capacitor of the invention is provided with a smectite layer and a first electrode and second electrode formed sandwiching it and facing each other, wherein the smectite layer has a dielectric constant from 8.5 to 10.5, and either or both the first electrode and second electrode preferably contain at least one metal selected from the group consisting Cu, Ni. In the capacitor of the invention having a dielectric film with the dielectric specified above, the dielectric film is capable of exhibiting sufficiently high dielectric constant. Cu, Ni, and are index pensive, and can yield a capacitor with lower cost than when using precious metal such as platinum, also, smectite have lower cost that other dielectric material such as mica, ceramic, and etc. This capacitor including thin dielectric layers having a thickness of about 0.6 to less than 2 micrometer.

Using such material can result in sufficiently high dielectric constant even when the dielectric film is a thin-film. This will yield an even more excellent capacitor, especially in term of minimized leak current.

The process of making smectite capacitor involves many steps. Mixing: Smectite powder is mixed with binder and solvents to create the slurry; this makes it easy to process the material. Tape Casting: The slurry is poured onto conveyor belt inside a drying oven, resulting in the dry smectite tape. This is then cut into square pieces called sheets. The thickness of the sheet determines the voltage rating of the capacitor. Screen Printing and Stacking: The electrode ink is made from a metal powder that is mixed with solvents and smectite material to make the electrode ink. The electrodes are now printed onto the smectite sheets using a screen printing process. This is similar to a t-shirt printing process. After that the sheets are stacked to create a multilayer structure. Lamination: Pressure is applied to the stack to fuse all the separate layers, this created a monolithic structure. This is called a bar. Cutting: The bar is cut into all the separate capacitors. The parts are now in what is called a ‘green’ state. The smaller the size, the more parts there are in a bar. Firing: The parts are fired in kilns with slow moving conveyor belts. The temperature profile is very important to the characteristics of the capacitors. Termination: The termination provides the first layer of electrical and mechanical connection to the capacitor. Metal powder is mixed with solvents and glass frit to create the termination ink. Each terminal of the capacitor is then dipped in the ink and the parts are fired in kilns. Plating: Using an electroplating process, the termination is plated with a layer of nickel and then a layer of tin. The nickel is a barrier layer between the termination and the tin plating. The tin is used to prevent the nickel from oxidizing. Testing: The parts are tested and sorted to their correct capacitance tolerances. At this point the capacitor manufacturing is complete.

The metal layer preferably include at least one metal selected from the group consisting of Cu, Ni, Si, and Sn. These metals while being inexpensive, are readily oxidized, but accruing to the production process of the invention it is possible to obtain a dielectric film capable of exhibiting high dielectric constant while adequately inhibiting oxidation even when using such metals. More preferably, the metal layer comprises Cu and the precursor layer is heated in the annealing step in a reduced pressure atmosphere with a pressure of 4×10⁻¹ to 8×10⁻¹ Pa as measured with an ionization vacuum gage.

Alternatively, and even more preferably, the metal layer comprises Ni and the pressure layer is heated in the annealing step in a reduced pressure atmosphere with a pressure of 2×10⁻³ to 8×10⁻¹ Pa as measured with ionization vacuum gage. This will allow formation of a high dielectric constant dielectric film in a more efficient manner while adequately inhibiting volatilization of the metal layer itself.

### BRIEF DESCRIPTION OF THE DRAWINGS

FIG. 1 is a sectional view showing a Multilayer Smectite Capacitor according to an embodiment of the present invention.

FIG. 2 is a sectional view showing a Multilayer Smectite Capacitor according to the second embodiment of the present invention.

### DESCRIPTION OF THE PREFERRED EMBODIMENTS

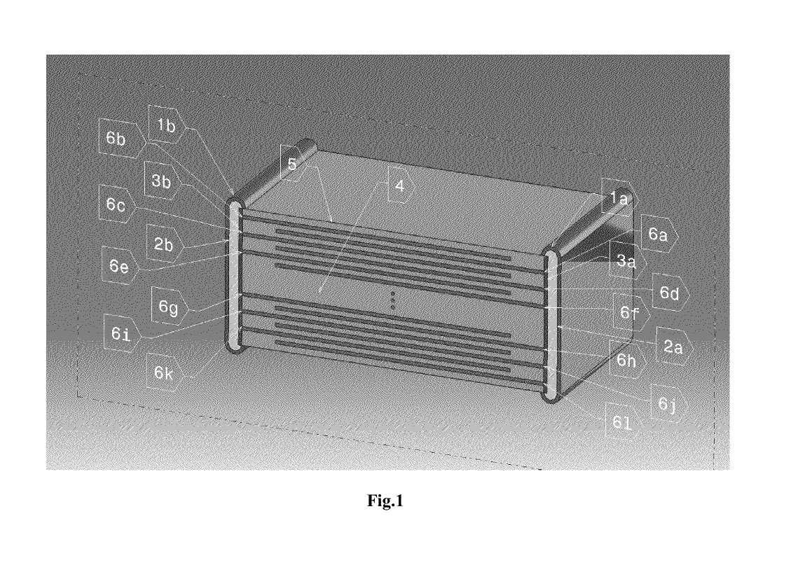

Embodiment of the present invention will now be described in detail. FIG. 1 is a sectional view showing a Multilayer Smectite Capacitor according to an embodiment of the present invention. The multilayer smectite capacitor includes a plurality of stacked dielectric layers 4 and thin internal conductors 6 that are each placed between the dielectric layers 4 and arranged in parallel. The dielectric layer 4 and internal conductors 6 have been prepared by a co-firing process and from a smectite body 5.

External conductors (nickel, copper and silver) 3a and 3b are each placed at both ends of the smectite body 5. First metal (nickel) coatings 2a and 2b are placed on the external conductors 3a and 3b, respectively, and second metal (tin) coating 1a and 1b are placed on the first metal coatings 2a and 2b, respectively.

The internal conductors 6 are arranged in parallel in the thickness direction on the ceramic body. The internal conductors 6 are classified in to the first conductors 6a, 6d, 6f, 6h, 6j, and 6l and second internal conductors 6b, 6c, 6e, 6g, 6i, and 6k. One of each of the first internal conductors 6a, 6d, 6f,6h, 6j, and 6l is electrically connected to the external conductors 3a and one of each second internal conductors 6b, 6c, 6e, 6g, 6i, and 6k is electrically connected to external conductor 3b, whereby static capacitors are formed between the first internal conductors 6a, 6d, 6f, 6h, 6j, and 6l and second conductors 6b, 6c, 6e, 6g, 6i, and 6k, respectively.

In this embodiment layer 4 has a thickness of about 0.6 to less than 2 micrometer. And internal conductors 6 have a thickness of about 0.2 or more to 0.4 or less micrometer. The internal conductors 6 each have spaces therein/there between. The total area percentage of the space in each internal conductor 6 is between 20 to 40 percent of the area of the internal conductors 6.

The reasons why the thickness of the dielectric layer 4 and internal conductors 6 and the area percentage of space are limited to the above range will now be described in detail. When the internal conductors 6 are caused to partially shrink such as that the spaces are formed in the internal conductors 6, the additive containing glass component principally containing Si is selectivity deposited in the spaces. The additive can be prevented from being segregated at grain boundaries or interface between the dielectric layers 4 and internal conductors 6, and capacitance and reliability are enhanced although the internal conductors 6 have a decrease area.

The dielectric layers 4 preferably have a small thickness. When the dielectric layer 4 have a thickness about or more, the capacitance thereof is too small to obtain MLSC having small size and high capacitance even if the dielectric layer 4 have large dielectric constant. In contrast, it is difficult to form dielectric layers that have thickness of less than 0.2 micrometer because of technical limitation. Thus, in the present invention the thickness of the smectite layer 4 is within of 0.2 to 2 micrometer.

When internal conductors have a thickness of less than 0.2 micrometer, the internal conductors partially shrink and therefore have a decrease area even if the internal are fired at a temperature lower that the melting point of a conductive material contained in the internal conductors. Therefore, the area of overlapping regions of the internal conductors facing each other is insufficient to obtain a desired capacitance. In contrast, when the internal conductors have a thickness of more than 0.4 micrometer, structure defects such as de laminations and cracks may occur due to increase in war page of layered body including stacked dielectric layer and internal conductors in common with printed electrode having a large thickness.

Thus In the present invention, the thickness of the internal conductors 6 is within 0.2 to 0.4 micrometer. The internal conductors 6 can be prevented from partially shrinking by using another sintering additive that is effective in sintering a smectite dielectric material at a lower temperature or by sintering a smectite dielectric material at temperature lower than the melting point of a metal component contained in the internal conductors 6. However, the total area percentage of the spaces in each internal conductors 6 is reduced to 20%. In contrast, when the total area percentage of the space in each two is 40% or more, the area of overlapping region of the internal conductors 6 facing each other is insufficient, hence, MLSC has an insufficient capacitance. Thus, in the present invention the total area parentage of the spaces in each internal conductor 6 is within a range 20 to 40%.

A process for producing the MLSC will now be described. The smectite powder contains the structural units of that can be derived from the structures of pyrophyllite and talc. Unlike pyrophyllite and talc, the 2:1 silicate layers of smectite have a slight negative charge owing to ionic substitutions in the octahedral and tetrahedral sheets. The net charge deficiency is normally smaller than that of vermiculite from 0.2 to 0.6 per O₁₀ (OH)₂ and is balanced by the interlayer cations as in vermiculite. This weak bond offers excellent cleavage between the layers.

The distinguishing feature of the smectite structure is that water and other polar molecules (in the form of certain organic substances) can, by entering between the unit layers, cause the structure to expand in the direction normal to the basal plane. Thus this dimension may vary from about 9.6 Å, when there are no polar molecules between the unit layers, to nearly complete separation of the individual layers.

The structural formula of smectites of the dioctahedral aluminous species may be represented by (Al₂yMg²⁺/y)(Si⁴−xAlx)O₁₀(OH)_{2M}+/x+y·nH₂O, where M⁺ is the interlayer exchangeable cation expressed as a monovalent cation and where x and y are the amounts of tetrahedral and octahedral substitutions, respectively (0.2≦x+y≦0.6). The smectites with y>x are called montmorillonite and those with x>y are known as beidellite. In the latter type of smectites, those in which ferric iron is a dominant cation in the octahedral sheet instead of aluminum and magnesium are called nontronite.

Although less frequent, chromium (Cr³⁺) and vanadium (V³⁺) also are found as dominant cations in the octahedral sheets of the beidellite structure, and chromium species are called volkonskoite. The ideal structural formula of trioctahedral ferromagnesian smectites, the series saponite through iron saponite, is given by (Mg,Fe²⁺)₃(Si⁴−xAlx)O₁₀(OH)^{2M}+/x·nH₂O.

The tetrahedral substitution is responsible for the net charge deficiency in the smectite minerals of this series. Besides magnesium and ferrous iron, zinc, cobalt, and manganese are known to be dominant cations in the octahedral sheet. Zinc dominant species are called sauconite.

There are other types of trioctahedral smectites in which the net charge deficiency arises largely from the imbalanced charge due to ionic substitution or a small number of cation vacancies in the octahedral sheets or both conditions. Ideally x is zero, but most often it is less than 0.15. Thus, the octahedral composition varies to maintain similar amounts of the net charge deficiency as those of other smectites. Typical examples are (Mg³−y Liy) for stevensite and hectorite, respectively.

According to the table below, be discovered that smectite mineral have higher dielectric constant than other material such as Mica, Polyester, Teflon and etc. Typical values for dielectric constant are as follows.

| | dielectric | | dielectric |
|---|---|---|---|
| Material | constant | Material | constant |
| Vacuum (reference) | 1.00000 | Polyethylene | 2.25 |
| Air (Sea Level) | 1.00059 | Polyester | 2.8-4.5 |
| Aluminum Oxide | 7-12 | Polypropylene | 1.5 |
| Ceramic | 5-6,000 | Polystyrene | 2.4-2.6 |
| Mica | 3-6 | Teflon | 2.0 |
| Mylar | 3.1 | Smectite* | 8.5-10.5¹* |
| Polycarbonate | 2.9-3.0 | | |

Increase in dielectric permittivity in Smectite Clay is related to: (a) a significantly high imaginary part of the relative permittivity; and (b) a frequency-dependent response (called dielectric dispersion). For smectites, a significant part of water is located between layers inside tactoids in intra-domain pores. Within tactoids or quasi-crystals, the corresponding interlayer spacing is either 18.6 A° for Ca-smectites, or 35 to 100 A° for Na.

However, clay minerals have been shown to exhibit dielectric dispersion to differing extents. Smectites also cause signal attenuation and dispersion, resulting in smaller signal amplitude and longer rise time. This means that the real (∈′) and imaginary (∈″) parts of the permittivity describing energy storage and energy losses respectively, change as a function of frequency. The smectites cause dispersion of the reflected signal, resulting in longer rise time, and evidence showed that there is a rise time related measurement error.

In general, Kaolinite and mica exhibits the lowest dispersion, smectites show the highest with Illite being somewhat intermediate. Therefore, according experimental results we obtain that smectite clay have dielectric constant value between 8.5-10.5.

In the MLSC of this embodiment, the dialectic layers 4 have a thickness of less than 2 micrometers describe above. In order to prepare the dielectric layer 4 with a small thickness, the average of particle size of the smectite powder is preferably fine and uniform. When the smectite powder had an average particle size of less than 100 nm, the smectite powder violently reacts with the additive, hence, the fired dielectric layer 4 have a large particle size, which causes deterioration in temperature coefficient and voltage coefficient of capacitance. In contrast, when the smectite powder has an average particle size more than 250 nm, the smectite powder has low reactivity with additive and cannot therefore be sintered at a low temperature.

Furthermore, the spaces in each internal conductor 6 have an excessively large area, which causes a decrease in capacitance and deterioration in electrical property. Therefore, MLSC with high reliability cannot obtain. Thus, the smectite powder preferably has an average particle size of 100 to 250 nm.

Next, the following additives are prepared, a sintering additive containing SiO₂, compound, a compound additive containing a rare-earth element, Ba, Zr, Mn, Mg, Si, B, Al, or Li. These additively are uniformly mixed with the smectite powder dispersed in an organic solvent, and the mixture is dried and then heated such that the organic solvent is removed from the mixture, whereby smectite ingredient powder is prepared. A predetermined amount of a binder, plasticizer, and organic solvent are mixed with the smectite ingredient powder in a ball mil by a wet process, whereby smectite slurry is prepared. The smectite slurry is then formed in to smectite sheets by a known method that shown above. On the other hand Metal films for forming the internal conductors 6 are prepared by a thin film forming process such as electro plating process.

The resulting metal layer is patterned using a resist material, whereby the metal films are formed on the PET Films. Since the internal conductors 6 are prepared using the metal films, a difference in thickness between the following portion of a layered body including the smectite sheets and the metal films can be reduced, a portion having the metal films and another portion having no metal filmed. Therefore, structural defects can be prevented from occurring in the layered body if the layered body includes a large number of layers. In order to manufacture the MLSC at low cost, a base metal such as nickel, copper, and tin is preferably used for forming the metal films.

The total area percentage of the spaces in each internal conductor 6 can be controlled by varying the thickness of the internal conductor 6 or changing a material for the metal films. The thickness of the internal conductor 6 can be ready controlled by preparing the internal conductor 6 by a thin films-forming process. The metal films preferably have such roughness of 50-60 nm. The metal films having such a surface roughness are usual for preparing elements having high reliability when the smectite sheets have a small thickness.

A large number of the smectite sheets each having the corresponding internal conductors 6 are stacked such that connection of the internal conductors 6 extending outside are alternately arranged, whereby the layered body is prepared. The binder is removed from the layered body, and the resulting layered body if firmed under an oxygen partial pressure of 10-9 MPa to 10-12 MPa in a reductive atmosphere containing H₂, whereby the sintered smectite body 5 is prepared.

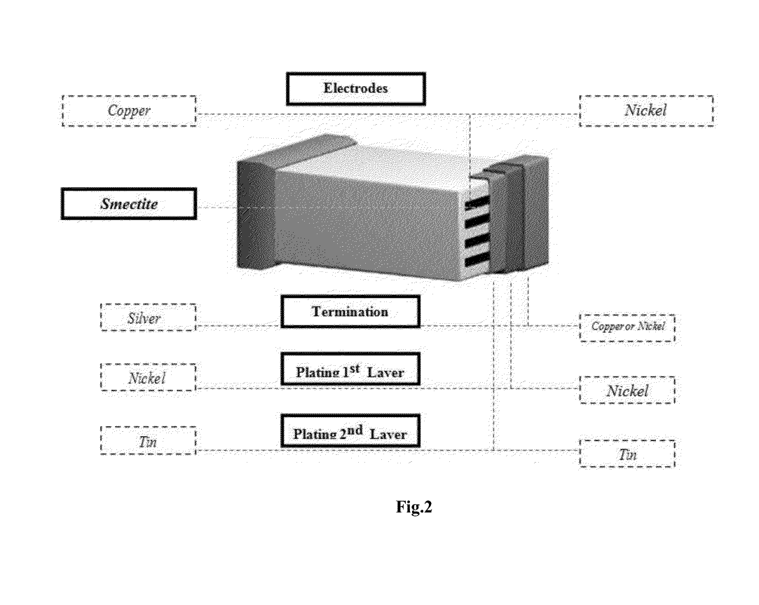

The resulting sintered smectite body 5 is then fired, whereby the external conductors, that are copper, nickel, and silver, 3a and 3b are each formed on the corresponding end faces. A conductive material contained in the internal conductors 6 or external conductors 3a and 3b is not particularly limited. The internal conductors 6 and external conductors 3a and 3b may contain the same material. The first containing, that is nickel, 2a and 2b are formed on the external conductors 3a and 3b, respectively, and the second metal coating, that is tin, 1a and 1b are formed on the first metal coating 2a and 2b, respectively, by an electroplating process, whereby the MLSC is obtained (FIG. 2).

As described above. In this embodiment, the thickness of the dielectric layer 4 is limited to a predetermined range; the thickness of the internal conductors 6 is limited to a predetermined range. Therefore, the MLSC that has high reliability and a large capacity and includes a large number of thin layers can be obtained.

It is understood that the above description and drawings are illustrative of the present invention and that changes may be made in as it is best known in the art without departing from the scope of the present invention as defined in the following claims.

We claim the following:

1. A multilayer smectite capacitor comprising: A capacitor body comprising stacking of plurality of dielectric sheets; a first and second internal conductors sandwiching at least one of said dielectric sheets; wherein said sheets are arranged in parallel and further comprising a signal terminal electrode disposed on a side face of said capacitor body and connected to one of said first and second internal conductors.

2. The multilayer smectite capacitor of claim 1, wherein each of said dielectric sheets forming said capacitor body are a smectite layer, and wherein said smectite layer has a dielectric constant of 8.5 to 10.5.

3. The multilayer smectite capacitor of claim 2, wherein either or both of said first and second internal conductors preferably comprise at least one of Cu, Ni or nickel alloy.

4. The multilayer smectite capacitor of claim 3, wherein said capacitor comprises a thickness of about 0.6 to less than 2 micrometer.

5. The multilayer smectite capacitor of claim 4, further comprising first and second external conductors placed at both ends of said capacitor body.

6. The multilayer smectite capacitor of claim 5, wherein two layers of a first metal coating are placed on either side of said first external conductor while another two layer of a second metal coating are placed on either side of said second external conductor

7. The multilayer smectite capacitor of claim 6, wherein said first metal coating is preferably nickel and said second metal coating is preferably tin.

8. The multilayer smectite capacitor of claim 7, wherein each one of said first and second internal conductors comprises of plurality of at least six iner-conductors; wherein said six iner-conductors of said first internal conductor are electrically connected to said first external conductor and wherein said six iner-conductors of said second internal conductor are electrically connected to said second external conductor; therefore forming a static capacitors between each one of said six iner-conductors of each one said first and second internal conductors respectively.

9. The multilayer smectite capacitor of claim 8, wherein said polarity of dielectric sheets comprise a thickness of about 0.6 to less than 2 micrometer and wherein said first and second internal conductors have a thickness of about 0.2 or more to 0.4 or less micrometer; and wherein each one of said first and second internal conductors comprise spaces there between, wherein said spaces are between 20 to 40 percent of an area of said first and second internal conductors respectively.

10. The multilayer smectite capacitor of claim 9, wherein said first and second external conductors, comprise copper, nickel, and/or silver.

11. The multilayer smectite capacitor of claim 10, further comprising a third and fourth metal coating formed on said first and second external conductors; wherein said third metal coating comprises two layers of nickel forming on either side of first external conductor and wherein said fourth metal coating comprises of two layers of tin formed on either side of said second external conductor; wherein said third and fourth metal coatings are formed by an electroplating process.
